(19) United States
(12) Patent Application Publication
(10) Pub. No.: US 2025/0246005 A1
(43) Pub. Date: Jul. 31, 2025

(54) PERFORMANCE TESTING FOR ROBOTIC SYSTEMS

(71) Applicant: Five AI Limited, Cambridge (GB)

(72) Inventors: Andrew Lawson, Cambridge (GB); David Pickup, Cambridge (GB)

(73) Assignee: Five AI Limited, Cambridge (GB)

(21) Appl. No.: 18/854,181

(22) PCT Filed: Apr. 6, 2023
(86) PCT No.: PCT/EP2023/059196

§ 371 Date: Oct. 4, 2024

(30) Foreign Application Priority Data
Apr. 7, 2022 (GB) 2205109.8

(51) Int. Cl. G06V 20/56; B60W 60/00; G06N 7/01; G06V 10/82

(52) U.S. Cl. CPC G06V 20/588; B60W 60/001; G06N 7/01; G06V 10/82; B60W 2420/403

(57) ABSTRACT

A computer-implemented method of generating lane detector outputs, the method comprising receiving a ground truth lane image containing one or more ground truth lane borders, each ground truth lane border comprising multiple border points; and generating a lane detector output image, by applying horizontal perturbations to the multiple border points of each ground truth lane border, the horizontal perturbations determined using a learned perturbation model, the learned perturbation model constructed to impose mutual correlation in the horizontal perturbations between vertically neighbouring border points of each ground truth lane border, and comprising parameters learned by performing a statistical analysis of lane detector errors computed between computed output images of a modelled lane detector and ground truth lane border annotations corresponding to the computed output images.

### TECHNICAL FIELD

This disclosure relates to performance testing of autonomous vehicles and other robotic systems. Performance testing is critical to ensure such systems can perform to a guaranteed level of safety.

### BACKGROUND

It has been estimated that, in order for an autonomous vehicle (AV) to achieve a level of safety that matches that of human drivers, a maximum of 1 error per 10\hat{ }7 autonomous driving decisions must be guaranteed across the entire Operational Design Domain (ODD) of the AV.

This presents an enormous challenge given the complexity both of an AV and the ODD itself. A self-driving system is an exceptionally complex assembly of cross-dependent and interacting software and hardware components, each prone to limitations or error. Several of the components use neural networks for object detection, type classification, action prediction and other critical tasks. That system needs to operate safely in the ODD. In this context, the ODD characterises all possible driving scenarios the AV might ever encounter and therefore itself holds infinite possibilities, with variables including road topologies, users, appearances, lighting, weather, behaviours, seasons, velocities, randomness and deliberate actions.

An industry standard approach to safety testing is based on actual driven test miles. A fleet of autonomous vehicles is driven by test drivers and a decision is characterised as unsafe when it is necessary for a test driver to intervene. Once an instance of test driver intervention has occurred in a particular real-world driving scenario, the circumstances of that driving scenario can be explored to isolate whatever factors caused the AV to behave unsafely and take appropriate mitigating action.

### SUMMARY

Simulation has been used for safety testing but is only useful if the simulated scenarios are sufficiently realistic. If an AV planner makes an unsafe decision in a simulated scenario that is completely unrealistic, that is much less useful in the context of safety testing than an instance of unsafe behaviour in a realistic scenario.

One approach runs simulations based on real-world scenarios in which test driver intervention was necessary. The sensor outputs from the AV are collected and can be used to reconstruct, in a simulator, a driving scenario which necessitated test driver intervention. Variables of the scenario may be “fuzzed” at a planning level in order to test variations of the real-world scenario that are still realistic. In this manner, more information about the cause of the unsafe behaviour can be obtained, analysed and used to improve prediction and planning models. However, a significant problem arises because, as the number of errors per decision reduces, the number of test miles that need to be driven in order to find a sufficient number instance of unsafe behaviour increases. A typical AV planner might take, on average, about 1 decision every two seconds. At an average speed of 20 miles per hour, that equates to around 90 decisions per mile driven. This, in turn, implies less than one error per 10\hat{ }5 driven miles in order to match a human level of safety. Robust safety testing would require many multiples of that to sufficiently test the AV across its ODD. This is exacerbated further as the perception stack evolves as, with every change to the perception stack, more test miles are needed. For those reasons, this approach is simply not viable when testing at a level of safety approaching that of humans.

There are other problems with existing approaches to simulation.

One approach is planning-level simulation but this fails to adequately account for the effect of perception errors. Numerous factors can influence perception errors such as weather, lighting, distance to or velocity of another vehicle, occlusion etc. An alternative would be full “photorealistic” simulation, in which the entire hardware and software stack of an AV is simulated. However, this in itself is an enormous challenge. An AV perception pipeline will typically be made up of multiple perception components which cooperate to interpret the AV's sensor outputs.

One problem is that certain perception components, such as Convolutional Neural Networks (CNNs), are particularly sensitive to the quality of the simulated data. Although it is possible to generate high quality simulated image data, the CNNs in perception are extremely sensitive to even the minutest deviations from real data. Therefore, these would require exceptionally high-quality simulated image data covering all possible conditions that an AV might encounter in the real-world (e.g. different combinations of simulated weather conditions, lighting conditions etc.)—otherwise their behaviour in a simulated scenario will not adequately reflect their behaviour in the real-world.

A second problem is that certain types of sensor data are particularly hard to model (simulate). Thus, even a perception system that is not particularly sensitive to the quality of the input data will give poor results, e.g. RADAR falls into the category of sensor data that is extremely difficult to simulate. This is because the physics of RADAR is inherently hard to model.

A third overarching problem is that of computational efficiency. Based on current hardware constraints, it is estimated that it might, at best, be possible to achieve photorealistic simulation in real-time (even if the other problems could be overcome).

The present disclosure provides simulation-based safety testing using what are referred to herein as “Perception Statistical Performance Models” (PSPMs, also referred to herein as ‘PRISMs’). A core problem addressed in this disclosure is that of simulating realistic perception outputs—that is, perception outputs with realistic errors—in a way that is not only more robust than photorealistic simulation but also significantly more efficient. In particular, the present disclosure provides a way of simulating realistic lane detection outputs that is based on observed correlations in observed lane detector errors.

PSPMs model perception errors in terms of probabilistic uncertainty distributions, based on a robust statistical analysis of actual perception outputs computed by a perception component or components being modelled. A unique aspect of PSPMs is that, given a perception ground truth (i.e. a “perfect” perception output that would be computed by a perfect but unrealistic perception component), a PSPM provides a probabilistic uncertainty distribution that is representative of realistic perception components that might be provided by the perception component(s) it is modelling. For example, given a ground truth 3D bounding box, a PSPM that models a 3D bounding box detector will provide an uncertainty distribution representative of realistic 3D object detection outputs. Even when a perception system is deterministic, it can be usefully modelled as stochastic to account for epistemic uncertainty of the many hidden variables on which it depends on practice.

Perception ground truths will not, of course, be available at runtime in a real-world AV (this is the reason complex perception components are needed that can interpret imperfect sensor outputs robustly). However, perception ground truths can be derived directly from a simulated scenario run in a simulator. For example, given a 3D simulation of a driving scenario with an ego vehicle (the simulated AV being tested) in the presence of external actors, ground truth 3D bounding boxes can be directly computed from the simulated scenario for the external actors based on their size and pose (location and orientation) relative to the ego vehicle. A PSPM can then be used to derive realistic 3D bounding object detection outputs from those ground truths, which in turn can be processed by the remaining AV stack just as they would be at runtime

Lane detection is an important task for a perception system of an autonomous vehicle stack. Typically, the vehicle plans paths to stay within driving lanes where possible and to maintain a central position within the driving lane. The vehicle's position relative to the lane boundaries is based on the perception of those lane boundaries being accurate. Errors in the perception of lane boundaries could cause the vehicle to move into a sub-optimal position within a driving lane, or even cross lane boundaries, which could be potentially unsafe. It is therefore important to generate realistic lane boundary errors in simulation, in order to identify potential problems arising from perception errors in lane detection.

The methods described herein provide a lane detector PRISM model that models correlations in errors between neighbouring points of a given lane, such that a large error at a given point is likely to propagate to some extent along the lane. This provides realistic errors on lane boundaries, since real lane detector errors are more likely to be correlated than random and isolated, and therefore generates realistic lane detection outputs in a simulation context. Further correlations, including correlations between different lane boundaries and correlations in time, may also be modelled to provide consistent and realistic lane boundary that are representative of the lane detection outputs of a perception system.

A first aspect herein provides a computer-implemented method of generating lane detector outputs, the method comprising: receiving a ground truth lane image containing one or more ground truth lane borders, each ground truth lane border comprising multiple border points; generating a lane detector output image, by applying horizontal perturbations to the multiple border points of each ground truth lane border, the horizontal perturbations determined using a learned perturbation model, the learned perturbation model constructed to impose mutual correlation in the horizontal perturbations between vertically neighbouring border points of each ground truth lane border, and comprising parameters learned by performing a statistical analysis of lane detector errors computed between computed output images of a modelled lane detector and ground truth lane border annotations corresponding to the computed output images.

The parameters of the perturbation model may define an error distribution, wherein the horizontal perturbations are determined by sampling from the error distribution.

The ground truth lane borders may be defined by a vector of values identifying the horizontal position of lane boundaries for each of a plurality of vertical positions within the ground truth lane image.

The output images of the modelled lane detector may comprise detected lane borders, wherein the lane detector errors are computed between the ground truth lane border annotations and detected lane border annotations of the detected lane borders.

The ground truth lane border annotations may comprise a polynomial ground truth curve.

The ground truth lane border points may be fitted to a polynomial curve.

The detected lane border annotations may comprise a polynomial lane detection curve for each detected lane border.

The horizontal perturbations may be determined based on a polynomial error function, the coefficients of the polynomial curve sampled from the at least one error distribution.

The parameters of the perturbation model may define the covariance of a multivariate Gaussian distribution, the covariance encoding correlations between errors for vertically neighbouring points of the ground truth borders, wherein the horizontal perturbations are determined by sampling from the multivariate Gaussian distribution.

The perturbation model may be further constructed to impose a correlation between horizontal perturbations of vertically corresponding points of neighbouring ground truth lane borders.

The method may comprise receiving a time series of ground truth images, each comprising respective ground truth lane borders, and generating a time series of lane detector output images, by applying horizontal perturbations to the multiple border points of each ground truth lane border to generate perturbed lane borders, wherein the perturbation model is further constructed to impose a correlation between corresponding perturbed lane borders for consecutive ground truth images of the time series of ground truth images.

Generating the lane detector output images may additionally comprise applying an existence model to the perturbed lane borders, wherein the existence model identifies at least some perturbed lane borders as undetected, wherein the undetected perturbed lane borders are omitted from the lane detector output images.

The existence model may be a Markov model, where each lane detector output image is associated with a detection state, and wherein the Markov model provides a probability of a detection state for each image based on the detection state of the previous image in the time series of lane detector output images.

A second aspect disclosed herein provides a computer-implemented method for testing an autonomous vehicle stack, the method comprising: running a simulated scenario in a simulator, in which a simulated agent plans and executes driving decisions in the simulated scenario in dependence on a time series of perception outputs computed for the simulated scenario, the perception outputs comprising at least one lane detection output image, wherein the lane detection output image is computed by: receiving a simulation ground truth lane image containing one or more ground truth lane borders, each ground truth lane border comprising multiple border points; applying horizontal perturbations to the multiple border points of each ground truth lane border, the horizontal perturbations determined using a learned perturbation model, the learned perturbation model constructed to impose mutual correlation in the horizontal perturbations between vertically neighbouring border points of each ground truth lane border, wherein the perturbation model comprises parameters learned by performing a statistical analysis of lane detector errors computed between computed output images of a modelled lane detector and ground truth lane border annotations corresponding to the computed output images.

Another aspect disclosed herein provides computer-implemented method of training a perturbation model for modelling lane detector outputs computed by a lane detector of an autonomous vehicle, the method comprising: applying the lane detector to a plurality of sensor outputs, thereby computing a plurality of computed lane detector output images comprising detected lane border annotations, wherein each computed lane detector output image is associated with a set of ground truth lane border annotations, the ground truth lane border annotations comprising a set of annotation points; comparing detected lane border annotations of each lane detector output image with the associated ground truth lane border annotation to determine a set of lane detector errors comprising a lane detector error value for each annotation point; and determining parameters of the perturbation model based on a statistical analysis of the lane detector errors, wherein the statistical analysis comprises modelling a correlation between lane detector error values of vertically neighbouring annotation points.

The ground truth lane border annotations may be generated in training or testing by projecting a lane boundary from a static road layout to the image plane of a camera, wherein the projection is based on a computed location of the camera within the road layout.

Another aspect herein provides a computer system for testing an autonomous vehicle stack, the computer system comprising: a simulator configured to run simulated scenarios comprising a simulated agent; a planner of the autonomous vehicle stack configured to make decisions for the simulated agent in dependence on one or more lane detection outputs computed for the simulated scenario; and a controller of the autonomous vehicle stack configured to generate a series of control signals for causing the simulated agent to execute the decisions of the planner as the simulated scenario progresses; wherein the computer system is configured to compute each lane detection output by: receiving a ground truth lane image containing one or more ground truth lane borders, each ground truth lane border comprising multiple border points; applying horizontal perturbations to the multiple border points of each ground truth lane border, the horizontal perturbations determined using a learned perturbation model; wherein the learned perturbation model is constructed to impose mutual correlation in the horizontal perturbations between vertically neighbouring border points of each ground truth lane border, and comprising parameters learned by performing a statistical analysis of lane detector errors computed between computed output images of a modelled lane detector and ground truth lane border annotations corresponding to the computed output images. Another aspect disclosed herein provides a computer program for programming one or more computers to implement the method or functionality of any preceding claim.

### BRIEF DESCRIPTION OF FIGURES

For a better understanding of the present disclosure, and to show how embodiments of the same may be varied into effect, reference is made by way of example only to the following figures in which:

FIG. 1A shows a schematic block diagram of an autonomous vehicle runtime stack;

FIG. 1B shows a schematic overview of an autonomous vehicle testing paradigm,

FIG. 1C shows a schematic block diagram of a scenario extraction pipeline,

FIG. 2 shows a schematic block diagram of a testing pipeline,

FIG. 2A shows further details of a possible implementation of the testing pipeline,

FIG. 3 shows an example of a real-world driving scenario;

FIG. 4A shows a testing pipeline using photorealistic simulation;

FIG. 4B shows an alternative PSPM-based testing pipeline in accordance with the present disclosure;

FIG. 5 shows an example of simulated image data, to which certain forms of perception component are highly sensitive;

FIG. 6 shows a schematic block diagram of training a PRISM for lane detection;

FIG. 7A shows a segmentation output by a lane detector model;

FIG. 7B series of points representing the lane boundaries;

FIG. 8 shows a model architecture for a lane detector PRISM; and

FIG. 9 shows an example Markov chain for a set of two lane boundaries.

### DETAILED DESCRIPTION

### Overview

The following description used the terms “PSPM” and “PRISM” interchangeably. A PRISM is a distribution over plausible perception outputs given some low-fidelity scene representation (perception ground truth). PRISMs and their applications are described in further detail in International Publication Nos. WO2021/037763, WO2021/037760, WO2021/037765 and WO2021/037761, which are hereby incorporated by reference in their entirety.

When making a safety case for an autonomous vehicle, it is impractical to perform all the required testing in the real world. However, constructing a simulation with such high fidelity that the vehicle's perception systems perform equivalently on real and simulated data is an unsolved problem. An approach referred to herein as “PRISM” addresses this problem by constructing a surrogate model of a perception system, including both the sensors and the perception component(s) that interpret the sensor data captured by the sensors.

Expanding on the above, ensuring self-driving technologies are provably safe requires testing of self-driving technologies in a very large number of situations. Performing this testing with real cars is expensive and time consuming. In natural scenarios, most miles that are driven will be uneventful in Great Britain in 2016, there were 136,621 injuries and 1,792 deaths due to road accidents, and 323.7 billion miles driven by all motor vehicles, which is only one accident every 2.4 million miles driven. Simulation must form part of a testing strategy for self-driving technologies. Simulated miles are much cheaper than real miles, and it is easier and safer to increase the number of hazards per mile in simulation than in the real world.

One approach to generating realistic perception outputs is via a high-fidelity simulation of the world, including sensor measurements. In this approach, ‘photo-realistic’ sensor readings are produced, which are fed to the car's software in place of real sensor readings, e.g. a realistic twin of the real world rendered as an image for input to perception. Such a rendering is shown in FIG. 5. The car software outputs control signals for the car's actuators, which are fed to a physics simulation. New sensor readings are produced based on the output of the physics simulation, closing the loop. This approach requires producing accurate models for tasks that range from challenging to unsolved:
The road surface, vehicle dynamics and other physical properties are possible to simulate with current technology, but not well understood.
GPS, IMU and wheel-encodings are possible to simulate, but getting their error statistics correct is important.
Visual appearance, camera lens and image sensor modelling are reasonably well understood, but high-fidelity rendering is slow.
Lidar modelling is similar to camera modelling, though with different material reflectance properties. The scanning nature of lidar is an additional complication.
Radar returns are very hard to model accurately with current technology, due to difficulty in modelling relevant material properties, detailed dependence on shapes and multiple reflections.
Worst of all, the neural networks that are state-of-the-art for visual object detection are extremely sensitive to detailed image statistics, and constructing synthetic images that cause the same network behaviour as equivalent real images is an unsolved problem.

Inaccurate models of the above sensors will affect the output of the perception modules in simulation, leading to potentially different ego behaviour. Such differences in behaviour limit how useful these simulations can be in assessing real world performance. Furthermore, running photorealistic simulations of the many miles necessary to verify the safe behaviour of an autonomous vehicle is expensive. This is because rendering photorealistic scenes is a slow, compute-intensive task requiring GPUs. High-fidelity simulation is difficult and expensive, and the conclusions from tests conducted using a high-fidelity simulation are unlikely to generalise to the real world.

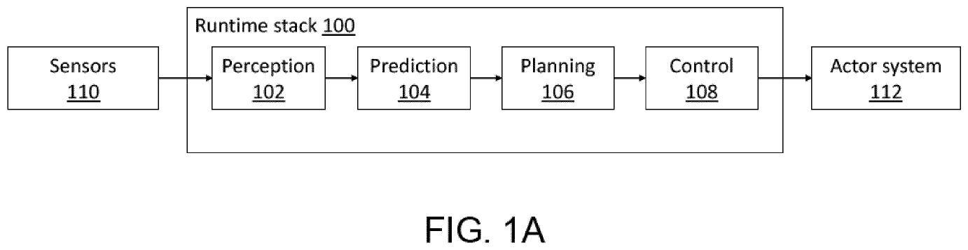

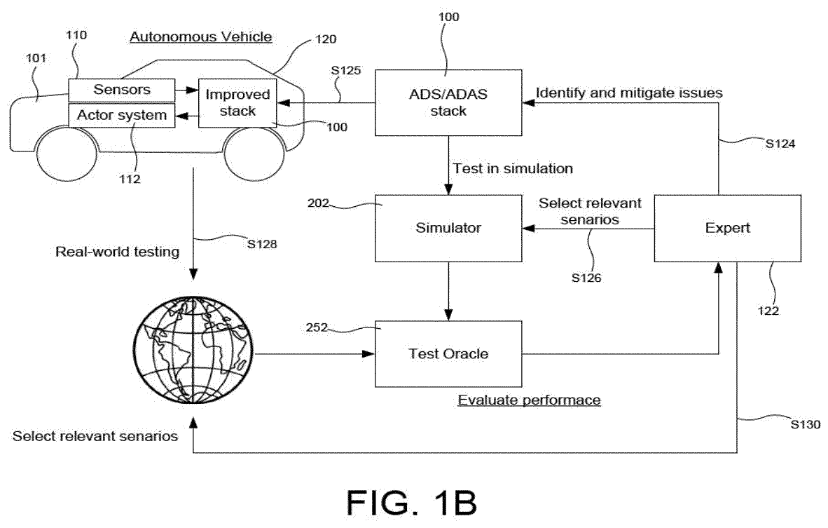

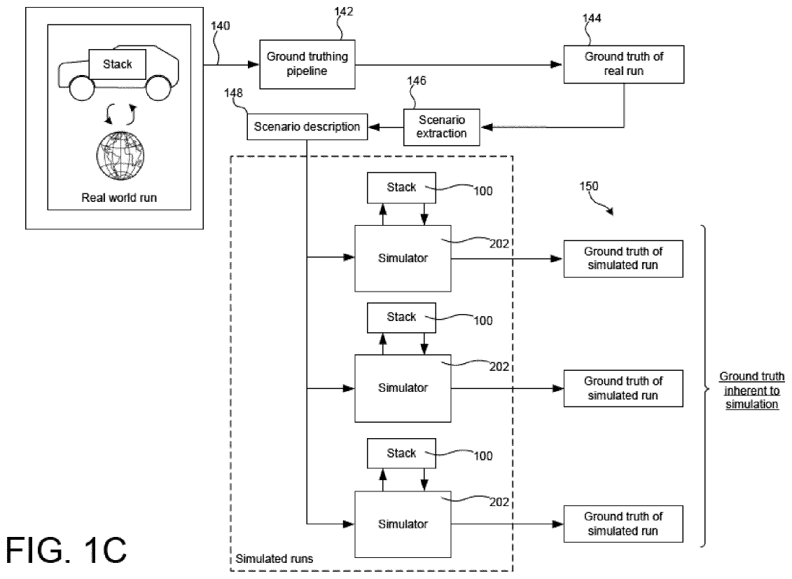

FIG. 1A shows a diagram of data flow through a decomposed autonomous vehicle stack 100. A perception system 102 receives sensor readings from the world and outputs a scene representation. A planning and prediction system (denoted separately by reference numerals 104 and 106) takes the scene representation and plans a trajectory through the scene. A control system 108 outputs control signals to the world that will cause the vehicle to follow the trajectory.

The perception system 102, planning and prediction system 104, 106 and control system 108 communicate with each other using well-defined interfaces. The perception system 102 consumes raw sensor data and processes it into a more abstract scene representation. This representation includes dynamic object pose, extent, motion and detection confidence. The planning and prediction system predicts the likely trajectories of other agents in the scene and plans a path through the scene that is safe, legal and comfortable. The control system consumes desired trajectories from the planning and prediction system and outputs control signals for the actuators.

In many cases, particularly in the case of the interface between perception and planning, these internal interfaces are easier to simulate than sensor readings. These interfaces may be leveraged for a second kind of simulation called low-fidelity simulation. It is possible to simulate only those aspects of the world that are necessary to reconstruct the abstract scene representation used by the planner, and feed that abstract scene representation directly to the planner, taking the perception system out of the loop. This avoids some of the burdens of high-fidelity simulation, but presents a new challenge: replicating the behaviour of the perception system. It is known that the perception system is not perfect and that its errors affect the prediction, planning and control systems in meaningful ways. Because the results of tests in simulation should generalise to the real world, it is necessary to be able to simulate realistic perception outputs.

An approach is presented for simulating realistic perception outputs using models called PRISMs. A PRISM is a distribution over plausible perception outputs given some low-fidelity scene representation. The mathematical framework that guides the creation of PRISMs is outlined, a prototype is created, and modelling choices are described. Doing this demonstrates that the modelling approach is sensible.

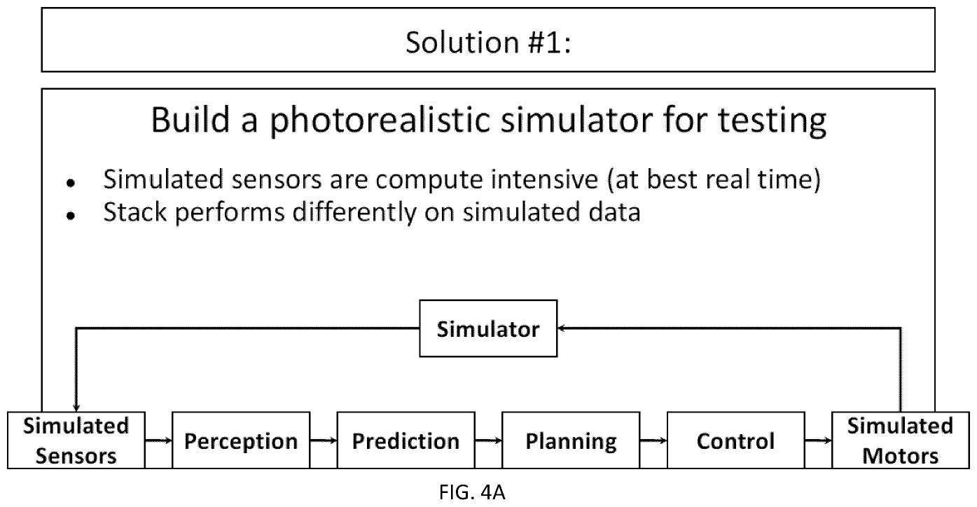

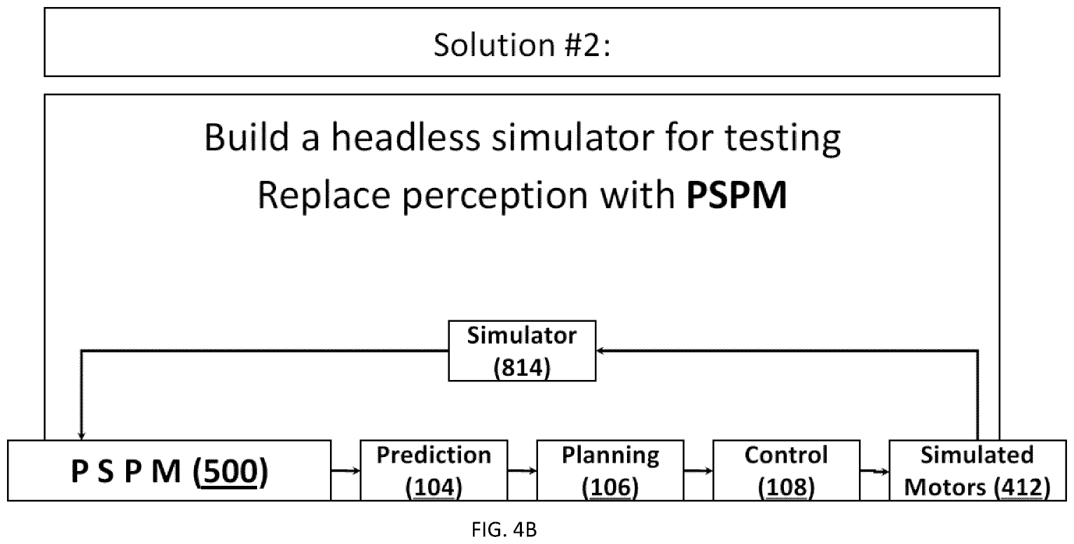

In summary, in high-fidelity simulation, the world is replaced with a simulator, treating the entire vehicle stack as a black box. In low-fidelity simulation, the world and the perception system 102 are replaced (see FIG. 4B and description below).

FIG. 1A shows a highly schematic block diagram of an AV runtime stack 100. The run time stack 100 is shown to comprise a perception (sub-)system 102, a prediction (sub-)system 104, a planning (sub-)system (planner) 106 and a control (sub-)system (controller) 108. As noted, the term (sub-)stack may also be used to describe the aforementioned components 102-108.

In a real-world context, the perception system 102 receives sensor outputs from an on-board sensor system 110 of the AV, and uses those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which cooperate to interpret the sensor outputs and thereby provide perception outputs to the prediction system 104.

In a simulation context, depending on the nature of the testing—and depending, in particular, on where the stack 100 is “sliced” for the purpose of testing (see below)—it may or may not be necessary to model the on-board sensor system 100. With higher-level slicing, simulated sensor data is not required therefore complex sensor modelling is not required.

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner (not shown).

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106. The actor system 112 includes “primary” vehicle systems, such as braking, acceleration and steering systems, as well as secondary systems (e.g. signalling, wipers, headlights etc.)

Note, there may be a distinction between a planned trajectory at a given time instant, and the actual trajectory followed by the ego agent. Planning systems typically operate over a sequence of planning steps, updating the planned trajectory at each planning step to account for any changes in the scenario since the previous planning step (or, more precisely, any changes that deviate from the predicted changes). The planning system 106 may reason into the future, such that the planned trajectory at each planning step extends beyond the next planning step. Any individual planned trajectory may, therefore, not be fully realized (if the planning system 106 is tested in isolation, in simulation, the ego agent may simply follow the planned trajectory exactly up to the next planning step; however, as noted, in other real and simulation contexts, the planned trajectory may not be followed exactly up to the next planning step, as the behaviour of the ego agent could be influenced by other factors, such as the operation of the control system 108 and the real or modelled dynamics of the ego vehicle). In many testing contexts, the actual trajectory of the ego agent is what ultimately matters; in particular, whether the actual trajectory is safe, as well as other factors such as comfort and progress. However, the rules-based testing approach herein can also be applied to planned trajectories (even if those planned trajectories are not fully or exactly realized by the ego agent). For example, even if the actual trajectory of an agent is deemed safe according to a given set of safety rules, it might be that an instantaneous planned trajectory was unsafe; the fact that the planner 106 was considering an unsafe course of action may be revealing, even if it did not lead to unsafe agent behaviour in the scenario. Instantaneous planned trajectories constitute one form of internal state that can be usefully evaluated, in addition to actual agent behaviour in the simulation. Other forms of internal stack state can be similarly evaluated.

The example of FIG. 1A considers a relatively “modular” architecture, with separable perception, prediction, planning and control systems 102-108. The sub-stacks themselves may also be modular, e.g. with separable planning modules within the planning system 106. For example, the planning system 106 may comprise multiple trajectory planning modules that can be applied in different physical contexts (e.g. simple lane driving vs. complex junctions or roundabouts). This is relevant to simulation testing for the reasons noted above, as it allows components (such as the planning system 106 or individual planning modules thereof) to be tested individually or in different combinations. For the avoidance of doubt, with modular stack architectures, the term stack can refer not only to the full stack but to any individual sub-system or module thereof.

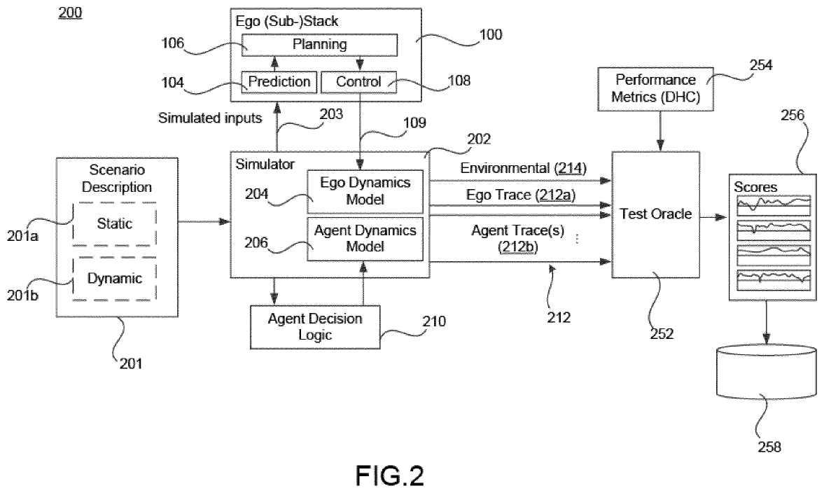

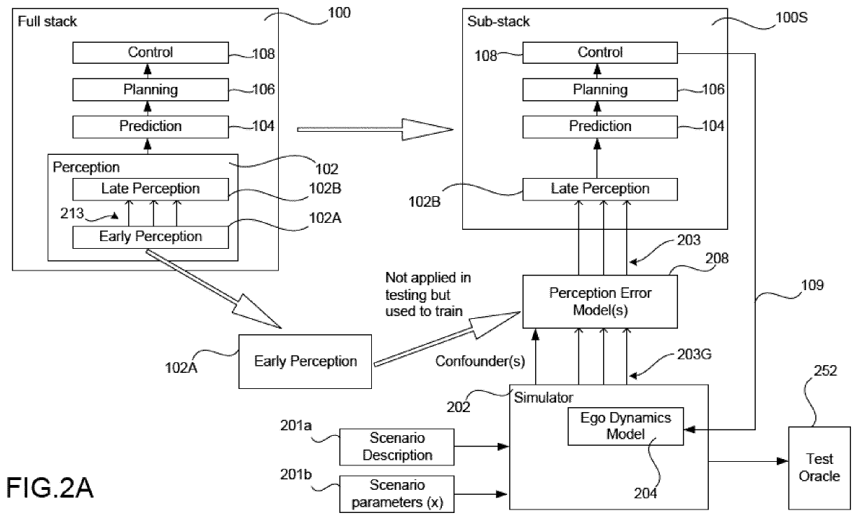

The extent to which the various stack functions are integrated or separable can vary significantly between different stack implementations—in some stacks, certain aspects may be so tightly coupled as to be indistinguishable. For example, in other stacks, planning and control may be integrated (e.g. such stacks could plan in terms of control signals directly), whereas other stacks (such as that depicted in FIG. 2A) may be architected in a way that draws a clear distinction between the two (e.g. with planning in terms of trajectories, and with separate control optimizations to determine how best to execute a planned trajectory at the control signal level). Similarly, in some stacks, prediction and planning may be more tightly coupled. At the extreme, in so-called “end-to-end” driving, perception, prediction, planning and control may be essentially inseparable. Unless otherwise indicated, the perception, prediction planning and control terminology used herein does not imply any particular coupling or modularity of those aspects.

It will be appreciated that the term “stack” encompasses software, but can also encompass hardware. In simulation, software of the stack may be tested on a “generic” off-board computer system, before it is eventually uploaded to an on-board computer system of a physical vehicle. However, in “hardware-in-the-loop” testing, the testing may extend to underlying hardware of the vehicle itself. For example, the stack software may be run on the on-board computer system (or a replica thereof) that is coupled to the simulator for the purpose of testing. In this context, the stack under testing extends to the underlying computer hardware of the vehicle. As another example, certain functions of the stack 110 (e.g. perception functions) may be implemented in dedicated hardware. In a simulation context, hardware-in-the loop testing could involve feeding synthetic sensor data to dedicated hardware perception components.

### Test Oracle

FIG. 1B shows a highly schematic overview of a testing paradigm for autonomous vehicles. An ADS/ADAS stack 100, e.g. of the kind depicted in FIG. 1A, is subject to repeated testing and evaluation in simulation, by running multiple scenario instances in a simulator 202, and evaluating the performance of the stack 100 (and/or individual subs-stacks thereof) in a test oracle 252. The output of the test oracle 252 is informative to an expert 122 (team or individual), allowing them to identify issues in the stack 100 and modify the stack 100 to mitigate those issues (S124). The results also assist the expert 122 in selecting further scenarios for testing (S126), and the process continues, repeatedly modifying, testing and evaluating the performance of the stack 100 in simulation. The improved stack 100 is eventually incorporated (S125) in a real-world AV 101, equipped with a sensor system 110 and an actor system 112. The improved stack 100 typically includes program instructions (software) executed in one or more computer processors of an on-board computer system of the vehicle 101 (not shown). The software of the improved stack is uploaded to the AV 101 at step S125. Step 125 may also involve modifications to the underlying vehicle hardware. On board the AV 101, the improved stack 100 receives sensor data from the sensor system 110 and outputs control signals to the actor system 112. Real-world testing (S128) can be used in combination with simulation-based testing. For example, having reached an acceptable level of performance though the process of simulation testing and stack refinement, appropriate real-world scenarios may be selected (S130), and the performance of the AV 101 in those real scenarios may be captured and similarly evaluated in the test oracle 252.

Scenarios can be obtained for the purpose of simulation in various ways, including manual encoding. The system is also capable of extracting scenarios for the purpose of simulation from real-world runs, allowing real-world situations and variations thereof to be re-created in the simulator 202.

FIG. 1C shows a highly schematic block diagram of a scenario extraction pipeline. Data 140 of a real-world run is passed to a ‘ground-truthing’ pipeline 142 for the purpose of generating scenario ground truth. The run data 140 could comprise, for example, sensor data and/or perception outputs captured/generated on board one or more vehicles (which could be autonomous, human-driven or a combination thereof), and/or data captured from other sources such external sensors (CCTV etc.). The run data is processed within the ground truthing pipeline 142, in order to generate appropriate ground truth 144 (trace(s) and contextual data) for the real-world run. As discussed, the ground-truthing process could be based on manual annotation of the ‘raw’ run data 142, or the process could be entirely automated (e.g. using offline perception method(s)), or a combination of manual and automated ground truthing could be used. For example, 3D bounding boxes may be placed around vehicles and/or other agents captured in the run data 140, in order to determine spatial and motion states of their traces. A scenario extraction component 146 receives the scenario ground truth 144, and processes the scenario ground truth 144 to extract a more abstracted scenario description 148 that can be used for the purpose of simulation. The scenario description 148 is consumed by the simulator 202, allowing multiple simulated runs to be performed. The simulated runs are variations of the original real-world run, with the degree of possible variation determined by the extent of abstraction. Ground truth 150 is provided for each simulated run.

### Simulation Context

Further details of the testing pipeline and the test oracle 252 will now be described. The examples that follow focus on simulation-based testing. However, as noted, the test oracle 252 can equally be applied to evaluate stack performance on real scenarios, and the relevant description below applies equally to real scenarios. The following description refers to the stack 100 of FIG. 1A by way of example. However, as noted, the testing pipeline 200 is highly flexible and can be applied to any stack or sub-stack operating at any level of autonomy.

FIG. 2 shows a schematic block diagram of a testing pipeline 200. The testing pipeline 200 is shown to comprise a simulator 202 and a test oracle 252. The simulator 202 runs simulated scenarios for the purpose of testing all or part of an AV run time stack, and the test oracle 253 evaluates the performance of the stack (or sub-stack) on the simulated scenarios.

The idea of simulation-based testing is to run a simulated driving scenario that an ego agent must navigate under the control of a stack (or sub-stack) being tested. Typically, the scenario includes a static drivable area (e.g. a particular static road layout) that the ego agent is required to navigate in the presence of one or more other dynamic agents (such as other vehicles, bicycles, pedestrians etc.). Simulated inputs feed into the stack under testing, where they are used to make decisions. The ego agent is, in turn, caused to carry out those decisions, thereby simulating the behaviour of an autonomous vehicle in those circumstances.

Simulated inputs 203 are provided to the stack under test. “Slicing” refers to the selection of a set or subset of stack components for testing. This, in turn, dictates the form of the simulated inputs 203.

By way of example, FIG. 2 shows the prediction, planning and control systems 104, 106 and 108 within the AV stack 100 being tested. To test the full AV stack of FIG. 1A, the perception system 104 could also be applied during testing. In this case, the simulated inputs 203 would comprise synthetic sensor data that is generated using appropriate sensor model(s) and processed within the perception system 102 in the same way as real sensor data. This requires the generation of sufficiently realistic synthetic sensor inputs (such as photorealistic image data and/or equally realistic simulated lidar/radar data etc.). The resulting outputs of the perception system 102 would, in turn, feed into the higher-level prediction and planning system 104, 106.

By contrast, so-called “planning-level” simulation would essentially bypass the perception system 102. The simulator 202 would instead provide simpler, higher-level inputs 203 directly to the prediction system 104. In some contexts, it may even be appropriate to bypass the prediction system 104 as well, in order to test the planner 106 on predictions obtained directly from the simulated scenario.

Between these extremes, there is scope for many different levels of input slicing, e.g. testing only a subset of the perception system, such as “later” perception components, i.e., components such as filters or fusion components which operate on the outputs from lower-level perception components (such as object detectors, bounding box detectors, motion detectors, lane detectors, etc.).

By way of example only, the description of the testing pipeline 200 makes reference to the runtime stack 100 of FIG. 1A. As discussed, it may be that only a sub-stack of the run-time stack is tested, but for simplicity, the following description refers to the AV stack 100 throughout. In FIG. 2, reference numeral 100 can therefore denote a full AV stack or only sub-stack depending on the context.

Whatever form they take, the simulated inputs 203 are used (directly or indirectly) as a basis for decision-making by the planner 108.

The controller 108, in turn, implements the planner's decisions by outputting control signals 109. In a real-world context, these control signals would drive the physical actor system 112 of AV.

In simulation, an ego vehicle dynamics model 204 is used to translate the resulting control signals 109 into realistic motion of the ego agent within the simulation, thereby simulating the physical response of an autonomous vehicle to the control signals 109.

To the extent that external agents exhibit autonomous behaviour/decision making within the simulator 202, some form of agent decision logic 210 is implemented to carry out those decisions and determine agent behaviour within the scenario. The agent decision logic 210 may be comparable in complexity to the ego stack 100 itself or it may have a more limited decision-making capability. The aim is to provide sufficiently realistic external agent behaviour within the simulator 202 to be able to usefully test the decision-making capabilities of the ego stack 100. In some contexts, this does not require any agent decision making logic 210 at all (open-loop simulation), and in other contexts useful testing can be provided using relatively limited agent logic 210 such as basic adaptive cruise control (ACC). One or more agent dynamics models 206 may be used to provide more realistic agent behaviour.

A simulation of a driving scenario is run in accordance with a scenario description 201, having both static and dynamic layers 201a, 201b.

The static layer 201a defines static elements of a scenario, which would typically include a static road layout, including lane boundaries, junctions and other static road features.

The dynamic layer 201b defines dynamic information about external agents within the scenario, such as other vehicles, pedestrians, bicycles etc. The extent of the dynamic information provided can vary. For example, the dynamic layer 201b may comprise, for each external agent, a spatial path to be followed by the agent together with one or both of motion data and behaviour data associated with the path. In simple open-loop simulation, an external actor simply follows the spatial path and motion data defined in the dynamic layer that is non-reactive i.e. does not react to the ego agent within the simulation. Such open-loop simulation can be implemented without any agent decision logic 210. However, in closed-loop simulation, the dynamic layer 201b instead defines at least one behaviour to be followed along a static path (such as an ACC behaviour). In this case, the agent decision logic 210 implements that behaviour within the simulation in a reactive manner, i.e. reactive to the ego agent and/or other external agent(s). Motion data may still be associated with the static path but in this case is less prescriptive and may for example serve as a target along the path. For example, with an ACC behaviour, target speeds may be set along the path which the agent will seek to match, but the agent decision logic 110 might be permitted to reduce the speed of the external agent below the target at any point along the path in order to maintain a target headway from a forward vehicle.

The output of the simulator 202 for a given simulation includes an ego trace 212a of the ego agent and one or more agent traces 212b of the one or more external agents (traces 212).

A trace is a complete history of an agent's behaviour within a simulation having both spatial and motion components. For example, a trace may take the form of a spatial path having motion data associated with points along the path such as speed, acceleration, jerk (rate of change of acceleration), snap (rate of change of jerk) etc.

Additional information is also provided to supplement and provide context to the traces 212. Such additional information is referred to as “environmental” data 214 which can have both static components (such as road layout) and dynamic components (such as weather conditions to the extent they vary over the course of the simulation). To an extent, the environmental data 214 may be “passthrough” in that it is directly defined by the scenario description 201 and is unaffected by the outcome of the simulation. For example, the environmental data 214 may include a static road layout that comes from the scenario description 201 directly. However, typically the environmental data 214 would include at least some elements derived within the simulator 202. This could, for example, include simulated weather data, where the simulator 202 is free to change weather conditions as the simulation progresses. In that case, the weather data may be time-dependent, and that time dependency will be reflected in the environmental data 214.

The test oracle 252 receives the traces 212 and the environmental data 214, and scores those outputs in the manner described below. The scoring is time-based: for each performance metric, the test oracle 252 tracks how the value of that metric (the score) changes over time as the simulation progresses. The test oracle 252 provides an output 256 comprising a score-time plot for each performance metric, as described in further detail later. The scores are output to be stored in a database 258, where they can be accessed, for example to display the results in a user interface as described above. The metrics 254 are informative to an expert and the scores can be used to identify and mitigate performance issues within the tested stack 100.

### Perception Error Models

FIG. 2A illustrates a particular form of slicing and uses reference numerals 100 and 100S to denote a full stack and sub-stack respectively. It is the sub-stack 100S that would be subject to testing within the testing pipeline 200 of FIG. 2.

A number of “later” perception components 102B form part of the sub-stack 100S to be tested and are applied, during testing, to simulated perception inputs 203. The later perception components 102B could, for example, include filtering or other fusion components that fuse perception inputs from multiple earlier perception components.

In the full stack 100, the later perception component 102B would receive actual perception inputs 213 from earlier perception components 102A. For example, the earlier perception components 102A might comprise one or more 2D or 3D bounding box detectors, in which case the simulated perception inputs provided to the late perception components could include simulated 2D or 3D bounding box detections, derived in the simulation via ray tracing. The earlier perception components 102A would generally include component(s) that operate directly on sensor data.

With this slicing, the simulated perception inputs 203 would correspond in form to the actual perception inputs 213 that would normally be provided by the earlier perception components 102A. However, the earlier perception components 102A are not applied as part of the testing, but are instead used to train one or more perception error models 208 that can be used to introduce realistic error, in a statistically rigorous manner, into the simulated perception inputs 203 that are fed to the later perception components 102B of the sub-stack 100 under testing.

Such perception error models may be referred to as Perception Statistical Performance Models (PSPMs) or, synonymously, “PRISMs”, as mentioned above. Further details of the principles of PSPMs, and suitable techniques for building and training them, may be bound in International Patent Application Nos. PCT/EP2020/073565, PCT/EP2020/073562, PCT/EP2020/073568, PCT/EP2020/073563, and PCT/EP2020/073569, incorporated herein by reference in its entirety. The idea behind PSPMs is to efficiently introduce realistic errors into the simulated perception inputs provided to the sub-stack 102B (i.e. that reflect the kind of errors that would be expected were the earlier perception components 102A to be applied in the real-world). In a simulation context, “perfect” ground truth perception inputs 203G are provided by the simulator, but these are used to derive more realistic perception inputs 203 with realistic error introduced by the perception error models(s) 208.

As described in the aforementioned reference, a PSPM can be dependent on one or more variables representing physical condition(s) (“confounders”), allowing different levels of error to be introduced that reflect different possible real-world conditions. Hence, the simulator 202 can simulate different physical conditions (e.g. different weather conditions) by simply changing the value of a weather confounder(s), which will, in turn, change how perception error is introduced.

The later perception components 102b within the sub-stack 100S process the simulated perception inputs 203 in exactly the same way as they would process the real-world perception inputs 213 within the full stack 100, and their outputs, in turn, drive prediction, planning and control. Alternatively, PSPMs can be used to model the entire perception system 102, including the late perception components 208.

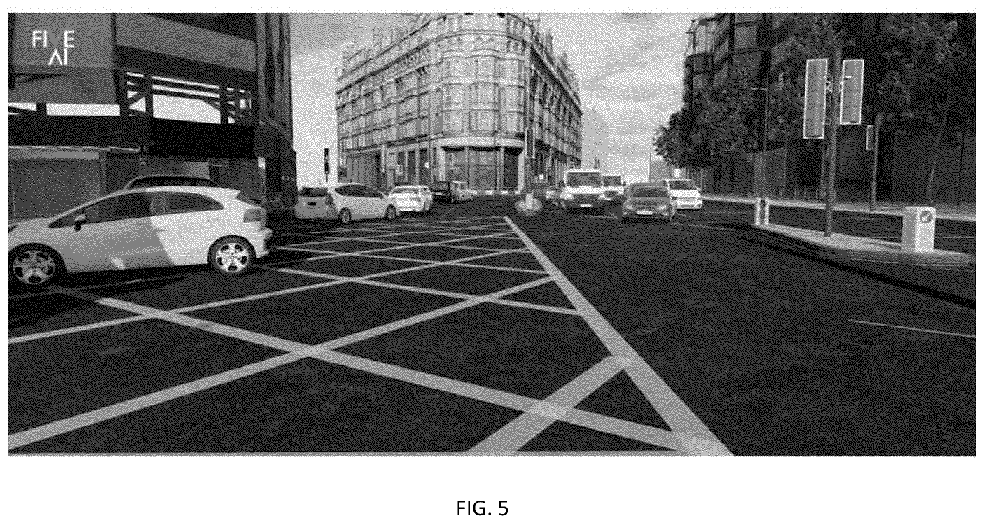

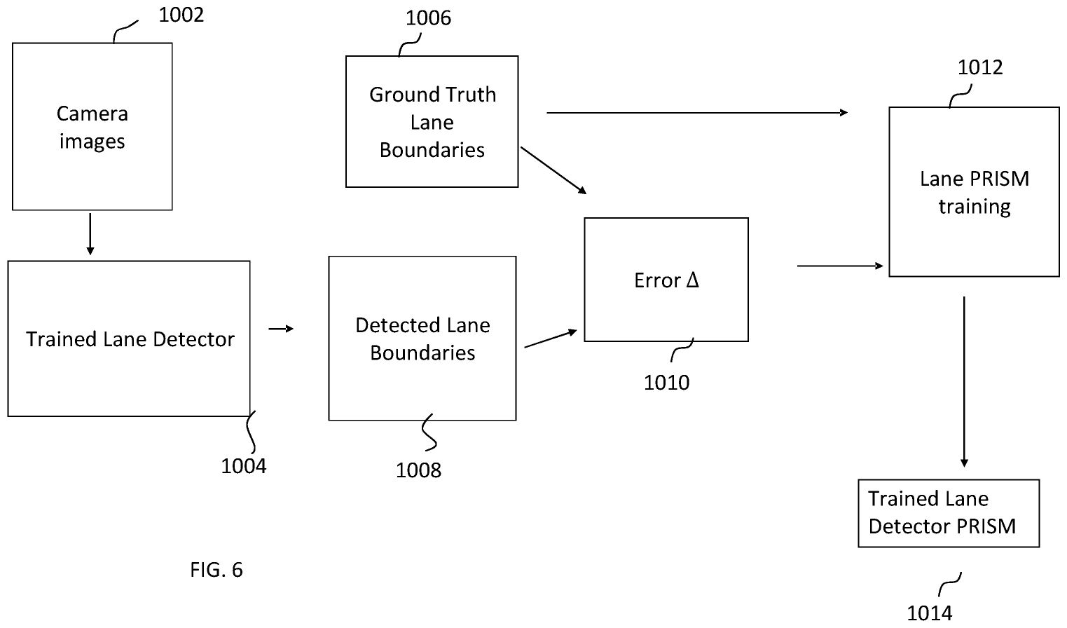

One possible perception error model that may be used in a testing pipeline as shown in FIG. 2A is a lane detector PRISM, which generates realistic lane detection perception outputs 203 approximating outputs of a lane detector within the perception sub-stack 102. Details of how a lane detector PRISM is trained and implemented are provided below with reference to FIGS. 6-9.

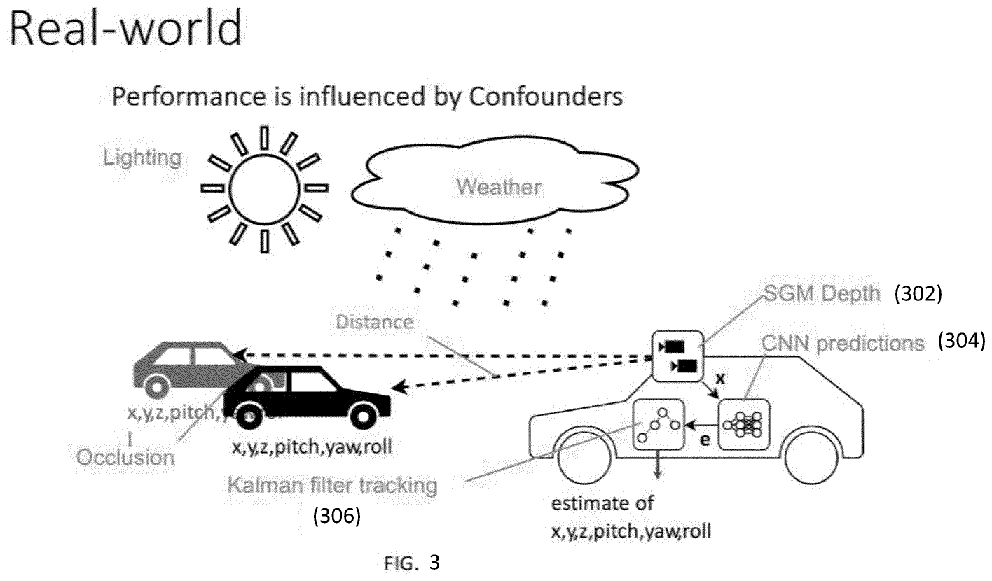

FIG. 3 shows an example of certain perception components which might form part of the perception stack 102, namely a 3D object detector 304 and a Kalman filter 306. This is a simplified example provided to illustrate the principles of PRISMs as applied to object detection, and it should be noted that other perception components may be included as part of a perception stack, including a lane detector, for which a PRISM is described in more detail below.

A depth estimator 302 captures stereo image pairs and applies stereo imaging (such as Semi-Global Matching) to extract depth estimates therefrom. Each depth estimate is in the form of a depth map, which assigns depth values to pixels of one image of the stereo image pair from which it is derived (the other image is used as a reference). The depth estimator 302 comprises a stereo pair of optical sensors and a stereo processing component (hardware and/or software) which are not shown separately. Both the optical sensors and the stereo processing component of the depth estimator 302 are considered part of the on-board sensor system 110 according to the terminology used herein (not the perception stack 102). The depth maps are one form of sensor output provided to the perception stack 102. The depth estimator 302 of FIG. 3 is just one example means of extracting depth from sensor data. Other depth estimators may be used to extract depth information, including ‘monocular’ depth extractors which extract depth information based on images from a single camera.

The 3D object detector 304 receives the depth estimates and uses them to estimate poses for external actors in the vicinity of the AV (ego vehicle). Two such external actors are shown, in the form of two other vehicles. Pose in this context means 6D pose, i.e. (x,y,z,pitch,roll,yaw), denoting the location and orientation of each external actor in 3D space.

FIG. 3 is highly simplified for the purposes of illustration. For example, it may be that the 3D object detector is formed of multiple cooperating perception components which collectively operate on sensor outputs of multiple sensor modalities. In order to illustrate certain core principles of PSPMs, a simplified example is considered in which the 3D object detector is assumed to operate on sensor outputs of a single modality (stereo depth).

In a real-world scenario, multiple physical conditions can influence the performance of the perception stack 102. As indicated, a physical condition which is treated as a variable in respect of a particular PSPM is referred to as a “confounder”. This allows variable physical conditions that are statistically relevant to a particular perception slice to be accounted for.

As mentioned, one approach to simulation would be to attempt photorealistic simulation of not only the entire runtime stack 100 of FIG. 1 but also the on-board sensor system 110 and the motors 112. This is illustrated in FIG. 4A. A challenge in this scenario is the simulation of sensor data: certain types of sensor data (e.g. RADAR) are inherently very difficult to simulate well and, whilst other types of sensor data (image data) are relatively easier to simulate, certain perception components, such as CNNs, are highly sensitive to even minute deviations from actual sensor data. Deviations between the data used in training such perception components and the actual sensor data received when deploying the system in the real world may be referred to as ‘domain shift’, which is a well-known problem in machine learning. Another challenge is the significant computational resources required to simulate both sensors and to run complex perception components such as CNNs.

For example, for the arrangement of FIG. 4A, it would require extremely high-quality depth maps to be simulated and the 3D object detector 304 to be run on those simulated depth maps. Even miniscule deviation in the simulated depth maps (compared to real depth maps provided the stereo depth estimator 202) could significantly impact the performance of the 3D object detector 304 during the simulation.

FIG. 4B provides a high-level schematic overview of PSPM based simulation. In this case a “headless” simulator set up is used, without the need to create simulated sensor data (e.g. simulated images, depth maps, LiDAR and/or RADAR measurements etc.), and without applying the perception stack 102 (or at least without applying it in full—see below). Instead, one or more PSPMs are used to efficiently compute realistic perception outputs, which in turn feed into higher-level components of the runtime stack 100 and are processed as they would be at runtime.

A PSPM is said to model a “perception slice” which can be all or part of the perception stack 102. A perception slice can be a single perception component or multiple cooperating perception components.

Mathematically, a perception slice may be represented as a function F where

e=F(x),

e being a perception output of the perception slice and x being a set of sensor outputs on which the perception component(s) operate.

On the AV at runtime, e is determined by applying F to x, which in turn is given by a sensor(s).

A PSPM mapped to a confounder space C may be represented as a function p where

p(e|t,c)

represents a probabilistic uncertainty distribution that provides the probability of F computing a perception output e given a perception ground truth t and a set of one or more confounders c (i.e. given a particular set of possible real-world conditions represented by the point c in the confounder space C) For example, for 2D bounding box detection:
F may be a CNN
x may be an RGB image
t could be a ground truth bounding box which can be computed directly from the simulation using ray tracing (without simulating x and without applying F), or a set of multiple such bounding boxes for multiple ground truth objects (set-to-set approach)
c might be distance and/or weather etc.

In the example of FIG. 3, e represents one or more 6D pose vectors computed by the 3D object detector 304 and x represents a depth map provided by the stereo depth estimator 302 from which e is derived.

### Lane Detector PRISM

A surrogate model for perception of lane boundaries will now be described. A lane detector is used as part of a perception system in order to provide information about the locations of lane boundaries to the prediction and planning components in order for the system to reason about the position of the ego relative to other agents in the scene and plan driveable paths within lanes. While PRISMs are described above for perception outputs such as bounding box detection, the same principles can be applied to model the error of a lane detector of a perception system. In this case the goal is to generate a distribution over realistic lane detections given a ground truth representation of the lanes in a given scenario. Note that two types of ground truth lane boundaries are described below. In training, ground truth lane boundaries are compared with the outputs of the lane detector to be modelled in order to analyse the errors of the lane detector as implemented by the perception component 102 of the stack. In the application of the model to test scenarios, the lane detector PRISM model is applied to a different set of ground truth lane representations (ground truth lane images), generating representative errors for the ground truth lane borders, allowing the lane detector model to produce realistic lane detection outputs in the form of lane detection output images. Ground truth lane borders used for training the lane detector model may be referred to elsewhere herein as ground truth lane border annotations.

A lane detector PRISM may be trained based on a set of training data comprising sensor outputs x and corresponding ground truth lane boundaries t, as described below with reference to FIG. 6, by applying a trained lane detector model to a set of sensor outputs comprising camera images to generate a set of corresponding perception outputs e comprising predicted lane boundaries. An error Δ is determined between the perception outputs generated by the trained lane detector and the ground truth lane boundaries t, and a set of parameters of a perception error model are fit to the errors. The learned model provides a distribution over errors given the set of model parameters θ, as well as any confounders.

Training images for modelling a lane detector for an AV stack should be representative of images of roads captured from an ego vehicle in typically encountered driving scenarios for the given AV. For example, where an AV stack is being tested for performance in highway scenarios, which typically comprise multiple lanes in each direction, the training data should include images of highway driving scenarios. Training data may be generated by manually annotating real world images with lane boundaries, or by using a set of images from a publicly available dataset which has already been annotated with lane boundaries. Alternatively, for simulated or real-world data, ground truth lane boundaries may be generated for an image based on known lane boundaries of a map (or ‘static layer’) in which the simulated or real driving scenario is located, by projecting the known lane boundaries of the map into the image plane based on a localisation of the vehicle. This is described in further detail below. This method of generating ground truth lane boundaries may be used to generate training data both for a lane detector component of an AV stack itself, for use in real-world driving, as well as for a lane detector PRISM model. In addition to training data, this method may be used to generate ground-truth lane boundaries in simulation when implementing the lane detector PRISM model in order to generate realistic lane detection outputs in simulation-based testing.

When modelling lane detection outputs using a PRISM, certain assumptions may be made about the form of the lane detection outputs and the errors associated with lane detections based on knowledge about road lanes and how they appear in images.

Firstly, it is expected that errors in lane border detections would depend on the distance of the portion of the lane being detected from the camera, as the size of a lane decreases, which in typical driving scenarios along a road corresponds with vertical position in the image plane. It is also reasonable to assume that errors for the same lane would be correlated along the lane, i.e. for neighbouring points along the lane in the vertical direction of the image plane.

A further assumption that can be applied in modelling lane detection errors is that the errors and lane detection outputs are smooth and continuous. For example, many lane detectors apply a step of fitting detected points of a lane boundary to smooth and continuous functions in order to generate smooth predicted lane border, reflecting the fact that lane boundaries are typically smooth continuous lines. In this case, to model the output of such lane detectors, the ground truth representation may also be fit to a continuous function, and the errors applied to that ground truth lane border representation by the PRISM model may be constrained to also be a continuous function so that the resulting lane detector output has the form of a smooth continuous lane border. Where the lane detection errors are modelled as a continuous function, such as a spline or a quadratic function, the correlation between errors in the horizontal position of the lane border at different vertical points of the image plane is implicit in the function itself, as the dependence of the error on vertical position is defined by the spline or quadratic function defined by the lane detection PRISM outputs.

In addition to correlation in the vertical direction, other correlations between lane detections and lane detection errors may be modelled. For example, if a lane detector mis-detects a lane boundary at a given vertical point in the image plane, and instead predicts the boundary to the left of its actual position in the image, a similar error may propagate to neighbouring lanes at approximately the same vertical position. Therefore, a lane PRISM model can take into account correlations between lanes in addition to correlations between errors along a lane. Time correlations may also be modelled, where an error in a lane detection for a single frame of a series of image frames captured on a given road is likely to propagate to subsequent frames. Modelling of correlations in the detection of lane borders is described in more detail with respect to an example lane detection PRISM below.

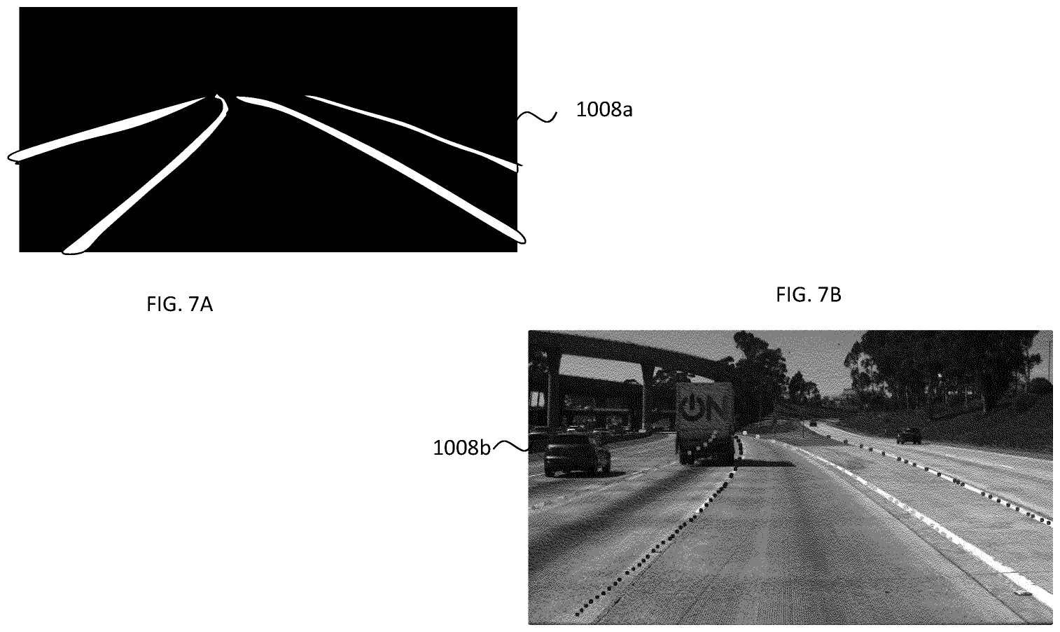

An example surrogate model (PRISM) for modelling lane detection errors will now be described in more detail with reference to FIG. 6. In this example, a lane boundary detector, which is used as part of a perception system, is already trained on a set of training data comprising camera images and ground truth lane detections. The lane detections output by the lane boundary detector may be in the form of a segmentation of pixels of the input image indicating which pixels belong to a lane boundary and which do not. An example of such a segmentation 1008a is shown in FIG. 7A, with the white segments representing the boundaries of the different lanes of the road. An example of such a lane detector model, LaneNet, is described in Neven, Davy, et al. “Towards end-to-end lane detection: an instance segmentation approach.”, which is hereby incorporated by reference in its entirety. The data used to train this example model is annotated with a series of equally-spaced values along the vertical y-axis of the image, each associated with a vector of x-values representing the horizontal position of the lane boundaries at that vertical (y) position of the image. As mentioned above, this training data may be obtained from existing datasets of highway driving images, or may be generated by manual or automatic annotation, including automatic annotation using localisation to project lanes of a map to an image plane.

In training the detector, and in training a PRISM to model the detector, as described further below, the error between the ground truth lane segments represented by a series of x-values for each y value, and the detector output represented by a set of pixel values, may be computed by transforming the segmentation to a set of x values representing the position of the lane boundary at each y value represented in the ground truth data. A series of points representing the ground truth lane boundaries are shown in FIG. 7B. Alternatively, the lane boundaries may be represented by a polynomial function, for example by fitting a spline to points of the ground truth lane boundaries.

FIG. 6 shows a schematic block diagram for training a PRISM to model a trained lane detector such as LaneNet. The training data comprises a set of camera images 1002 with road scenes having one or more lanes, for example captured by a camera mounted to a vehicle while driving. The camera images used in training of the PRISM have an associated set of ground truth annotations 1006 identifying the lanes captured in each image, for example as a series of y values, each having a vector identifying the x-position of lane boundaries at that vertical position in the image. As mentioned above, the trained lane detector outputs a set of detected lanes or lane boundaries, which may or may not be in the same format as the ground truth boundaries 1006. If the detections are in a different format to the ground truth, an appropriate transformation is applied to the detection, for example to convert a segmentation output identifying pixels belonging to a lane boundary to a set of points representing the lane boundaries as described above, so that an error between the ground truth and detected lane boundaries can be computed directly. For this example, the error for each lane boundary prediction at a given y-value can be computed by computing a distance to the ground truth position of the nearest boundary for that y-value.

A set of errors can be computed for the training set by comparing the output of the lane detector 1004 with the ground truth 1006. Training of the PRISM uses the ground truth, as well as any other confounders, as defined above, as inputs and the set of errors as outputs in order to learn parameters θ of a model 1014 which predicts a lane detection output for a given ground truth input 1220, described later.

An example lane detection error model will now be described in more detail. In this model, a number of assumptions are made regarding the errors of the lane detection model. The first assumption is that the errors are dependent on y-position only, i.e. they are independent of the horizontal position in the image. This is based on the assumption that vertical position, which in images captured from a moving ego vehicle is generally indicative of distance from the ego vehicle, is a stronger determinant of detection accuracy than horizontal position, i.e. whether the lane is central to the ego or to the side. A second assumption is that there is some correlation between errors of the same lane at different y-values. A third assumption is that errors of neighbouring lanes at the same y-value are correlated. Finally, there is an assumption that errors in one frame of a series of captured image frames are correlated with errors in previous and subsequent frames.

In the above-described model of errors, only positional errors are considered. However, there is also the possibility of a lane detector failing to detect a lane boundary or only detecting part of the lane boundary's length. To include this, a separate existence model may be created, which can be applied after a model of the detector's positional errors. In other words, the combined model can first determine for the ground truth a set of errors on the position of the lanes, and afterwards apply an existence model to categorise a subset of the lane boundaries as not detected or only partially detected. The positional error model may also be referred to herein as a ‘detection error model’.

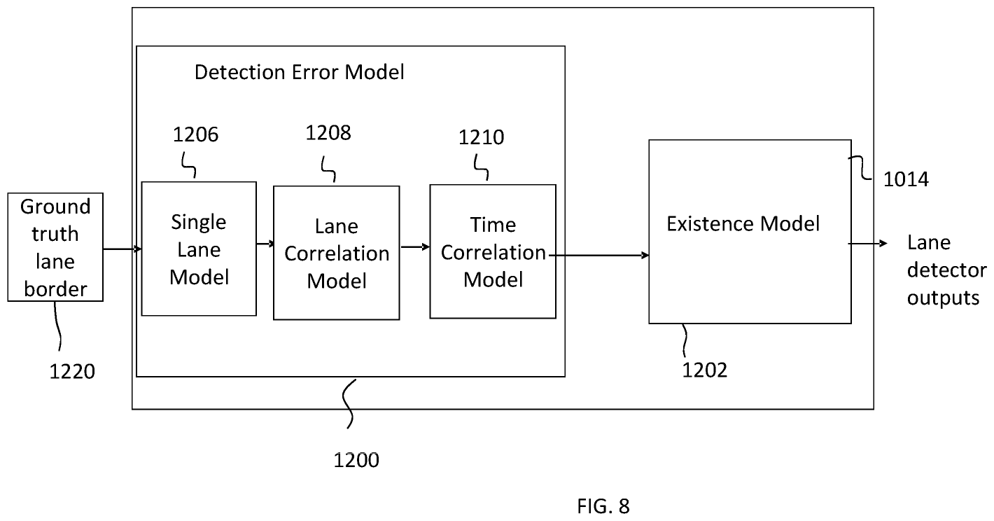

FIG. 8 is a schematic block diagram showing the structure of an example lane detection PRISM model which may be applied to a simulation ground truth lane border image in simulation-based testing in order to generate realistic lane detection outputs. In this architecture, the problem of generating realistic lane detections is split into firstly applying positional errors to the ground truth lane borders, based on learned errors of the detections compared with the ground truth by a detection error model 1200, and secondly applying errors in the existence of the detections, i.e. false negatives and/or partial detections by an existence model 1202.

The detection error model 1200 works by first generating errors for a single lane using a single lane model 1206, with the outputs of the single lane model providing independent errors for different lanes within a given image frame. These are used by a lane correlation model 1208, to generate errors which take into account correlations between adjacent lanes, in order to generate more realistic errors for the full set of lanes in a given image frame. Finally, a time correlation model 1210 is applied across errors generated independently for multiple frames of the image data, and a set of errors for a set of camera images are generated, which can be applied directly to ground truth lane boundaries in order to obtain realistic lane detector outputs with respect to errors in the position of the lane boundaries, but these outputs do not take into account existence errors. An existence model 1210 is applied to the lane detections generated based on the detector error model in order to determine which lanes are detected and which are not. Each of the components of FIG. 8 will now be described in further detail, with reference to specific examples of suitable models for lane detection error, correlations, and existence errors.

As mentioned above, the inputs to training the PRISM include errors of the detection when compared to a ground truth set of lane boundaries. In some embodiments, the training data annotations may be fit to a curve, such as a quadratic function, as this results in smooth road boundaries. In this case, the detections are also fit to a function of the same type, as this provides a more appropriate set of errors, given that the best possible prediction that a detector can make for a quadratic ground truth is the same quadratic curve. Furthermore, it simplifies the amount of information that must be captured by the model.

The generation of positional errors for a single lane according to the positional error model will now be described. As mentioned above, it is assumed that the error is dependent on y position only.

One possibility for the single lane model 1206 is to apply a Gaussian error model, with the covariance between errors at different y-values given by a covariance matrix:

$$Cov ( {y}_{i} , {y}_{j} ) = [ {σ}_{11} {σ}_{12} … 0 , {σ}_{21} {σ}_{22} … 0 , 00 … {σ}_{nn} ]$$

Correlations between errors with large separations are assumed to be zero since correlations are expected to be small at these distances. The non-zero elements of the above covariance matrix are estimated from the errors 1010 generated from the training data according to known methods for estimating covariance, in order to define an error model for determining a set of errors for a single lane, ignoring correlations in time or from adjacent lanes.

In order to generate correlated errors for a single lane, a Cholesky decomposition of the above covariance matrix is determined as Cov=LL*. A series of errors for a given lane Y can then be determined by generating a vector X_{N} of N samples from a normal distribution with mean 0 and variance 1. A set of errors E_{N} obtained according to the following formula:

$${E}_{N} = L \cdot {X}_{N}$$

satisfies the covariance matrix defined above.

In the above example model, where the errors are modelled as a multi-variate Gaussian, the elements of the covariance matrix σᵢⱼ defining the correlations between errors at different y-values of the image, are learned parameters of the PRISM model which are used to generate a set of errors that are correlated between neighbouring vertical positions. These parameters are learned by fitting to the training data comprising ground truth lane annotations and corresponding lane detector errors.

An alternative model for the single lane model 1206 for generating errors for each lane makes an additional assumption that a lane boundary can be modelled as a smooth curve. One way to represent a lane boundary is to fit it to a cubic spline. Higher order polynomials may also be used to model the lane boundary sections, but cubic splines are preferred. If both the ground truth and detected lane boundaries are representable as a cubic spline, it can be assumed that the error on lane detections can also be modelled as a smooth curve.

This allows a model of errors as coefficients of a cubic spline fit to the error between the ground truth boundaries 1006 and lane detections 1008.

In a simple example, where the lane is modelled as a single cubic polynomial, the error on a lane detection can be modelled as:

$$Error ( y ) = {a}_{0} + {a}_{1} y + {a}_{2} {y}^{2} + {a}_{3} {y}^{3} + ϵ$$

with each of the coefficients a₀, a₁, a₂, a₃ being coefficients determined for an individual error in the training data by fitting the cubic function to the errors for the given data point, and e being a residual error term modelling noise in the data. This is based on the assumption that the errors will generally follow a smooth continuous function, but with small fluctuations. The error is modelled by fitting a set of coefficients of the above expression for each data point and then fitting a distribution over the coefficients for all examples in the training data. Each ‘data point’ or example in the training data represents a single row for a single image frame. Modelling the errors a smooth polynomial spline as described above introduces vertical correlations to the errors.

A distribution is fit for the set of coefficients and residual errors determined for each data sample, and this distribution can be used to generate errors to be applied to ground truth data in order to generate realistic lane detection outputs, by sampling from the determined distributions and applying the sampled coefficients to the y-coordinates of the ground truth lane detections to generate a value for the error as above. The residual errors and the polynomial coefficients may be treated as two separate components of the error model, and may be fit to different types of distributions depending on the form of the coefficients and residual errors fit to the given data. For example, the coefficients may be found to best fit to a Laplace distribution, while the residual errors are fit to a Gaussian or Student's t-distribution.

In this example, the PRISM model the parameters of the distribution(s) fit to the coefficients of the spline for each example of the training data are the learned parameters of the model which define the horizontal errors (also referred to herein as horizontal perturbations) applied at different vertical positions of the image plane, and the correlations along the vertical direction are enforced by the form of the lane detection errors as a spline or other smooth continuous function. In general, errors increase with increasing distance from the vehicle.

Within the ground truth lane image, such as that shown in FIG. 7B, the errors would therefore generally increase with increasing vertical position within the image (i.e. increasing values of the y-coordinate).

Either of the above models can be used as the single lane model 1206 to generate errors for an individual lane, with no correlation between lanes generated independently using these models. In order to take correlations between errors at different horizontal positions (i.e. in different lanes), an adjacent lane detection model (i.e. lane correlation model 1208) is used.

This model uses observed correlations between neighbouring lanes to define an adjacent lane model. Errors E_{ego} are generated for the ego lane and an uncorrelated set of errors E_{adj}^{uncorr} can be generated for an adjacent lane using one of the error models described above. The ego lane is chosen as the basis for this model as in general this is the longest lane in the image and is defined for the full length of adjacent lanes.

The correlated errors of the adjacent lane are modelled as:

$${E}_{adj}^{corr} = ρ ( y ) {E}_{ego} + \sqrt{1 - {ρ ( y )}^{2}} {E}_{adj}^{uncorr}$$

where ρ(y) is a correlation coefficient between lane errors of adjacent lanes at each value of y, which is to be determined from the training data.

This model only considers correlations between directly neighbouring lanes. The same model is applied to generate errors for the remaining lanes in the image based on those already determined.

The individual lane model 1206 and adjacent lane model 1208 together generate a set of errors for lanes of a single image, which allows generation of realistic lane detections given a set of ground truth lane boundaries. However, errors from one frame to the next frame in a series of captured frames are likely to be highly correlated. A time correlation model 1210 can be used to include the dependence of errors at a given time on errors for previous timesteps. Given a lane detection result Z(t) for a given timestep t, errors at a subsequent time t+dt can be generated in a similar way to the adjacent lane model described above, by determining a correlation coefficient ξ(y, dt) which depends on the amount of time dt that has passed between the two frames, as well as the y-position in the image.

Given a full lane detection result Z(t) at time t as well as an uncorrelated detection result Z^{uncorr}(t+dt) for a later timestep, both generated according to the models described above, a correlated lane detection Z^{corr}(t+dt) can be generated as follows:

$${Z}^{corr} ( t + dt ) = ξ ( y , dt ) Z ( t ) + \sqrt{1 - {ξ ( y , dt )}^{2}} {Z}^{uncorr} ( t + 1 ) .$$

The correlation is determined based on the training data. A constant (in time) correlation can be used where there is an expectation that consecutive pairs of images are evenly spaced. However, the correlation for different timescales may be measured in order to capture the autocorrelation function across separations of different lengths rather than a single step.

It should be noted that the above function is a correlation of the lane detections, i.e. the modelled lane boundaries obtained by applying the errors determined by the single lane error models above to a ground truth boundary, and not to the errors. A strong correlation would be expected between lane detections in one frame and lane detections in the next frame. Correlations in the error itself from frame to frame may also occur.

In a model taking into account correlations along the lane in addition to correlations between lanes and between image frames, the PRISM learns a set of multiple parameters, defining either the correlation parameters for errors of a single lane or a distribution over fit coefficients for a spline or other continuous function defining an individual lane, as well as correlation parameters p and defining lane and time correlations. These parameters may be fit to training data using known fitting techniques.

Alternatively, some or all of the parameters defining the lane boundary model may be learned by training a neural network to predict the parameters based on a set of training data. For example, to learn to predict a set of parameters defining distributions over fit coefficients defining splines or continuous functions for the error on lane boundaries, a neural network can be trained on a set of training examples comprising ground truth representations and corresponding error splines for a set of lane detector predictions. The neural network output is a set of parameters defining a distribution over fit parameters and the network weights are updated in training so as to maximise the likelihood of the observed error splines according to the predicted distributions. This is just an example of how a neural network could be used to implement a subset of the PRISM model by predicting distributions over spline parameters, which can subsequently be sampled to generate error splines for individual lanes. The parameters of the overall model may be predicted by a single neural network, or fit to training data by known methods, or a combination of neural networks and data fitting may be used to determine the parameters of the model.

The second component of the lane detection PRISM is the existence model 1202. This model determines how much of the lane detections produced by the detection error model 1200 to report in the final output of the lane detector PRISM 1014. When the existence model 1202 and the detection error model 1200 are combined, the existence model may determine that a given lane boundary is not detected in a given frame of a series of image frames. However, even when the detection model results in no lane boundary being output, the detection error model output are still maintained for the purposes of generating future detection errors, in order to maintain the time correlation between frames, such that when the lane ‘reappears’ in the lane detection output, the time correlation in the positional errors are correctly modelled.

A model for the rate of false negative lane detection can be obtained for the given lane detection model 1004 by reviewing the detections of the training data and plotting them against the number of ground truth detections. A suitable model for the rate of false negatives for lane detections can then be inferred based on the observed pattern. For example, where the number of false negatives increases linearly with the number of lanes encountered, this indicates that the rate of false negatives is constant and that false negatives can be modelled as a Poisson process according to a Poisson distribution:

$$P ( {N}_{lanes} ) = \frac{{( {rN}_{lanes} )}^{{N}_{fn}} {e}^{- {rN}_{lanes}}}{{N}_{fn} !} .$$

Sampling from this distribution provides a number of false negatives (i.e. missed detections) for a given number of actual lanes. One way to apply this to lane detections is to randomly sample false negatives according to the rate, without considering that different lanes may have different rates of false negatives and that there is a correlation between missed detections in from one from one frame to the next.

However, one way to encode this structure is to model the lane detections in each frame in a Markov chain, with each state defining whether each of the lanes of the given frame are detected or not detected, and transition probabilities between each state and all the other states.

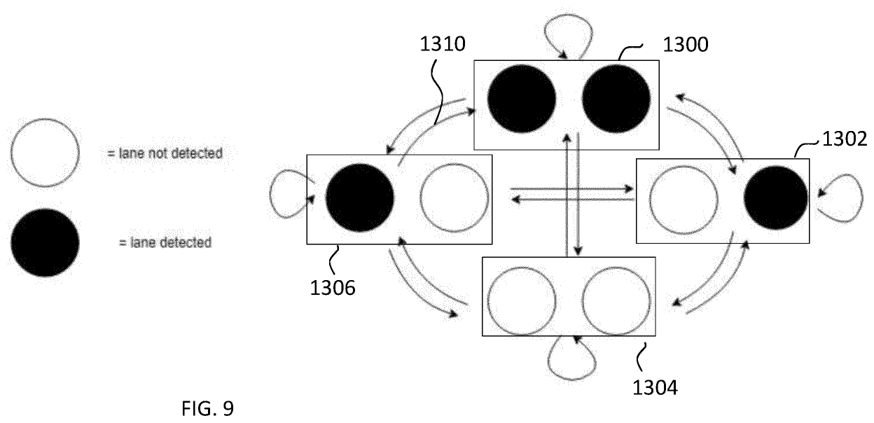

In a simplified example, only the two lane boundaries of the ego lane are modelled. FIG. 9 shows a diagram of a simple Markov chain describing the states and transition probabilities for this simplified case. As shown in FIG. 9, there are four possible states. Each state is represented by two dots, each relating to one of the lane boundaries, i.e. the left dot representing the detected state of the left boundary and the right dot representing the detected state of the right boundary. As indicated in FIG. 9, a black dot represents the given lane boundary being detected, while a white dot represents the detection of the given boundary being missed. State 1300 represents the case where both boundaries are detected, state 1302 represents the case where the right boundary is detected but the left boundary is not detected, state 1306 represents the case where the left boundary is detected but the right boundary is not, and state 1304 represents the case where neither boundary is detected.

Each of the states have an associated transition probability to all states of the system. The transition probabilities are indicated by arrows between states in FIG. 9, for example, the probability that at a next timestep both boundaries are detected where at the current timestep only the left boundary is detected is given by the arrow labelled 1310. Arrows returning to the same state represent the probability of remaining in that state from one step to the next.

These transition probabilities can be estimated by analysing the training data and identifying how often particular transitions between detections and non-detections occur from one step to the next. For an example lane detector that outputs only full lane boundaries for a given image frame, the existence model computes transition probabilities for the full lane detection from one timestep to the next. However, other lane detectors may be trained to identify subsets of lane sections, in which case the existence model would provide a detection state for each section of the lane boundary within a single image. It should be noted that the more granular the lane detection model is, the more training data is required the lane detector PRISM, due to a larger number of model parameters to fit.

The above model describes the detection states and transition probabilities for a single lane. However, most driving scenarios involve the detection of multiple lanes and an extension of the model, for example to describe four lane boundaries instead of two would mean that 16 states would need to be described, and there would be 256 transition probabilities between these states. For a model with N lane boundaries, there are 2^{N} states and 4^{N} transition probabilities to determine from data. In practice, where detecting more than three lanes, this model would require very large amounts of data to accurately determine transition probabilities. Simplifying assumptions may be made in order to reduce the state space for larger models. For example, it may be assumed that some transition probabilities are so low that they can be excluded, for example in a three-lane scenario where only the far left lane boundary is detected at a given timestep, it is extremely unlikely that at the next timestep only the far right lane boundary of the rightmost lane is detected. If such situations are not observed in the data then they may be excluded from the model.

Training of the lane detector PRISM may be performed separately for different driving contexts, such that multiple lane detection models are available for use depending on the road layout of the driving scenario. For a highway driving scenario, three types of model may be needed: one for a single lane, one for two lanes, and one for three lanes (each of these having 2L+1 boundaries, where L is the number of lanes). For two- and three-lane highway scenarios, multiple models may be trained to account for different driving positions within the highway layout. In other words, for a three-lane carriageway, there would be a separate model for when the ego is driving in the leftmost lane, the central lane and the rightmost lane. Each of these models is trained on ground truth images of lanes from the point of view of a vehicle in the respective lane, which may be manually or automatically annotated data collected from a real-world driving run where the vehicle was driving in that lane.

The models may have some similarities and therefore an approach that enables simultaneous training of the multiple models may be appropriate. A hidden Markov model (HMM) may be used for modelling in this way. However, it is relatively rare in real life driving scenarios to transition between different highway layouts, for example from a two-lane carriageway to a three-lane carriageway, and therefore acquiring training data to train a model for both is potentially difficult. An alternative way to combine different models, where either the road layout or the lane of the AV changes within the scenario, would be to design heuristics to switch from one model to another, for example by manually tuning transition probabilities between the different possible models.

Once the models are learned, they can be applied to a ground truth lane image in order to generate realistic lane detection outputs in simulation which can be used to test the performance of an autonomous vehicle stack. As mentioned above, there are various ways to generate ground truth data for training a lane detector 1004 and a lane detector PRISM 1014 such as those described above, including manual or automatic annotation of images collected from a camera mounted on an autonomous vehicle. An example method of automatically annotating such images for generating ground truth lane representations in real images is described above. The same principles also apply to simulated ground truth images used in the implementation of the trained lane detector PRISM to simulation-based testing.

### Ground Truth Generation

The above-described lane detector PRISM model 1014 is trained using training data comprising ground truth images with representation of lane boundaries within the image plane, and corresponding outputs of a lane detector model with a representation of the lane boundaries detected by the model for the given ground truth lane boundaries. References to ‘images’ herein are not limited only to camera images capturing real-life scenarios, but also refer to simulated ground truth lane boundary representations in an image plane of the AV. As mentioned above, both the lane detector model 1004 and the lane detector PRISM 1014 may be trained based on annotated images from a known dataset appropriate to the intended driving use-case, or may be manually or automatically annotated for real or simulated data. One method of annotating real and simulated data suitable for training the lane detector model 1004 and lane detector PRISM described above will now be described. The below description will refer to the generation of ground-truth lane annotations for simulated data, but the methods described also apply to real-world images.

In simulation, a driving scenario comprises a static layer, which includes static features of the drivable region in which the scenario occurs, and a dynamic layer which includes dynamic elements such as vehicles, pedestrians, bicycles, etc., each having a motion profile throughout the simulated scenario. The static layer may be in the form of a map of a road layout, which may be generated based on annotated real-world data collected by AVs driving in roads, and/or from CCTV, or received from an existing database of maps. In these maps, the layout of lanes are generally annotated, providing a ‘ground truth’ representation of the lanes of a real or simulated driving scenario. Similarly, for real-world driving, the ground truth lanes in which a vehicle is driving can be obtained from a map of the real-world road layout.

For testing, the goal is to generate lane boundaries representative of those output by the perception stack of the AV, i.e. within an image plane of a sensor of the AV. To generate a corresponding ground truth representation for lane detection, the ground truth lane boundaries of the static layer may be projected into the image plane based on a location of the AV, which can be determined accurately in real-world driving scenarios using localisation methods such as inertial navigation system (INS) that include real-time kinetic (RTK) positioning corrections. In simulation-based testing, the position of the ego vehicle and its sensors is inherent to the simulation of the scenario, and so a mapping of the ground-truth static layer to a ground-truth image representation of the lane boundaries can easily be determined based on the location of the simulated agent and simulated sensor position. The ground truth lane boundaries may be represented by a series of points projected into the image plane, which may be fit to a cubic spline.

The generation of ground truth lane boundaries within an image based on a static layer representation of the lane boundaries, for example to generate ground truth training data, has advantages over manual annotation of images of the road by a human annotator, as it is not affected by occlusion of lane boundaries within the image. This can be used to generate ground truth lane boundaries within real images captured by an AV, which can then be used for training a lane detector 1004, as well as the lane detector PRISM 1014. In the implementation of the lane detector PRISM for simulated scenarios, the location of the ego vehicle within the simulated scenario is known and can be used to generated a simulated image with ground truth lane boundaries from the point of view of an on-board sensor of the AV.

1. A computer-implemented method of generating lane detector outputs, the method comprising:
receiving a ground truth lane image containing one or more ground truth lane borders, each ground truth lane border comprising multiple border points; and
generating a lane detector output image, by applying horizontal perturbations to the multiple border points of each ground truth lane border, the horizontal perturbations determined using a learned perturbation model;
the learned perturbation model constructed to impose mutual correlation in the horizontal perturbations between vertically neighbouring border points of each ground truth lane border, and comprising parameters learned by performing a statistical analysis of lane detector errors computed between computed output images of a modelled lane detector and ground truth lane border annotations corresponding to the computed output images.

2. The method of claim 1, wherein the parameters of the perturbation model define an error distribution, and wherein the horizontal perturbations are determined by sampling from the error distribution.

3. The method of claim 1, wherein the ground truth lane borders are defined by a vector of values identifying a horizontal position of lane boundaries for each of a plurality of vertical positions within the ground truth lane image.

4. The method of claim 1, wherein the output images of the modelled lane detector comprise detected lane borders, and wherein the lane detector errors are computed between the ground truth lane border annotations and detected lane border annotations of the detected lane borders.

5. The method of claim 1, wherein the ground truth lane border annotations comprise a polynomial ground truth curve.

6. The method of claim 1, wherein the ground truth lane border points are fitted to a polynomial curve.

7. The method of claim 4, wherein the detected lane border annotations comprise a polynomial lane detection curve for each detected lane border.

8. The method of claim 2, wherein the horizontal perturbations are determined based on a polynomial error function, coefficients of the polynomial curve sampled from the at least one error distribution.

9. The method of claim 1, wherein the parameters of the perturbation model define covariance of a multivariate Gaussian distribution, the covariance encoding correlations between errors for vertically neighbouring points of the ground truth borders, and wherein the horizontal perturbations are determined by sampling from the multivariate Gaussian distribution.

10. The method of claim 1, wherein the perturbation model is further constructed to impose a correlation between horizontal perturbations of vertically corresponding points of neighbouring ground truth lane borders.

11. The method of claim 1, comprising receiving a time series of ground truth images, each comprising respective ground truth lane borders, and generating a time series of lane detector output images, by applying horizontal perturbations to the multiple border points of each ground truth lane border to generate perturbed lane borders, wherein the perturbation model is further constructed to impose a correlation between corresponding perturbed lane borders of consecutive ground truth images of the time series of ground truth images.

12. The method of claim 11, wherein generating the lane detector output images additionally comprises applying an existence model to the perturbed lane borders, wherein the existence model identifies at least some perturbed lane borders as undetected, wherein the undetected perturbed lane borders are omitted from the lane detector output images.

13. The method of claim 12, wherein the existence model is a Markov model and each lane detector output image is associated with a detection state, wherein the Markov model provides a probability of a detection state for each image based on the detection state of a previous image in the time series of lane detector output images.

14.-16. (canceled)

17. A computer system for testing an autonomous vehicle stack, the computer system comprising:
at least one memory configured to store computer-readable instructions; and
at least one hardware processor coupled to the at least one memory and configured to execute the computer-readable instructions, which upon execution cause the at least one hardware processor to implement:
a simulator configured to run simulated scenarios comprising a simulated agent;
a planner of the autonomous vehicle stack configured to make decisions for the simulated agent in dependence on one or more lane detection outputs computed for the simulated scenario; and
a controller of the autonomous vehicle stack configured to generate a series of control signals for causing the simulated agent to execute the decisions of the planner as the simulated scenario progresses; wherein the computer system is configured to compute each lane detection output by:
receiving a ground truth lane image containing one or more ground truth lane borders, each ground truth lane border comprising multiple border points;
applying horizontal perturbations to the multiple border points of each ground truth lane border, the horizontal perturbations determined using a learned perturbation model; wherein the learned perturbation model is constructed to impose mutual correlation in the horizontal perturbations between vertically neighbouring border points of each ground truth lane border, and comprising parameters learned by performing a statistical analysis of lane detector errors computed between computed output images of a modelled lane detector and ground truth lane border annotations corresponding to the computed output images.

18. A non-transitory medium embodying computer-readable instructions configured, when executed on one or more hardware processors, to train a perturbation model for modelling lane detector outputs computed by a lane detector of an autonomous vehicle by performing a method comprising:
applying the lane detector to a plurality of sensor outputs, thereby computing a plurality of computed lane detector output images comprising detected lane border annotations, wherein each computed lane detector output image is associated with a set of ground truth lane border annotations, the ground truth lane border annotations comprising a set of annotation points;
comparing detected lane border annotations of each lane detector output image with the associated ground truth lane border annotation to determine a set of lane detector errors comprising a lane detector error value for each annotation point; and
determining parameters of the perturbation model based on a statistical analysis of the lane detector errors, wherein the statistical analysis comprises modelling a correlation between lane detector error values of vertically neighbouring annotation points.

19. The computer system of claim 17, wherein the simulated agent plans and executes driving decisions in the simulated scenario in dependence on a time series of perception outputs computed for the simulated scenario, the perception outputs comprising at least one lane detection output image.

20. The computer system of claim 17, wherein the ground truth lane border annotations are generated in training or testing by projecting a lane boundary from a static road layout to an image plane of a camera, wherein the projection is based on a computed location of the camera within the road layout.
